(19) United States
(12) Patent Application Publication
(10) Pub. No.: US 2026/0287378 A1
(43) Pub. Date: Sep. 24, 2026

(54) TRAVEL TIME ESTIMATION METHOD, TRAVEL TIME ESTIMATION DEVICE, TRAVEL TIME ESTIMATION SYSTEM, AND STORAGE MEDIUM

(71) Applicant: HONDA MOTOR CO., LTD., Tokyo (JP)

(72) Inventors: Kimihiko Hiroi, Wako-shi (JP); Hideaki Shimamura, Wako-shi (JP); Yusuke Matsumoto, Wako-shi (JP)

(21) Appl. No.: 19/537,858

(22) Filed: Feb. 12, 2026

(30) Foreign Application Priority Data
Mar. 24, 2025 (JP) 2025-048503

(51) Int. Cl. G01C 21/34

(52) U.S. Cl. CPC G01C 21/3492

(57) ABSTRACT

A travel time estimation system includes: a server having a processing unit; and a terminal device having each sensor and a vehicle control unit. The vehicle control unit transmits travel information of a moving body and information on an external environment to the server on the basis of an output of each sensor. The processing unit acquires an estimated travel time of a moving body M, by adding a reference travel time of the moving body and a variable travel time that varies according to the external environment, on the basis of a history of each of the travel information of the moving body and the information on the external environment. The processing unit transmits information related to the estimated travel time to the terminal device.

### CROSS-REFERENCE TO RELATED APPLICATION

Priority is claimed on Japanese Patent Application No. 2025-048503, filed in Japan on Mar. 24, 2025, the entire content of which is incorporated herein by reference.

### BACKGROUND OF THE INVENTION

### Field of the Invention

The present invention relates to a travel time estimation method, a travel time estimation device, a travel time estimation system, and a storage medium.

### Description of Related Art

In recent years, efforts to provide access to sustainable transportation systems in consideration of vulnerable people among traffic participants are becoming active. In order to achieve this, research and development for further improving traffic safety and convenience are focused on, through research and development in navigation technologies.

Conventionally, for example, regarding an occurrence probability of an average rate, there is known an information providing system that predicts an average rate of travel in a predetermined area by calculating a subsequent probability using a Bayes' formula from an advance probability based on travel records in the past and a conditional probability based on travel records in the past and new travel records (see, for example, Patent Document 1 below).

[Patent Document 1] Japanese Unexamined Patent Application, First Publication No. 2009-157798

### SUMMARY OF THE INVENTION

A problem in the navigation technology is to improve reliability and versatility of prediction by predicting a travel time, an arrival time, and the like in detail in a predetermined route. For example, in a system as in the above related art, there arises a problem that it is not possible to grasp a degree of contribution and the like of various factors at a time of occurrence of delay by only using the average rate based on a travel time and a travel distance as the travel record data. For example, in a case where it is not possible to grasp a degree of contribution of a delay factor related to traveling, there arises a problem that it is not possible to improve reliability and versatility of prediction of a travel time in a situation where there is a possibility of delay occurrence, a situation where the possibility of delay occurrence varies, and the like.

In order to solve the above problem, an object of an aspect according to the present invention is to achieve improvement in reliability and versatility of travel time estimation. Furthermore, the present invention contributes to development of a sustainable transportation system.

In order to solve the above problem and achieve the object, the present invention adopts the aspects in the following.

(1) A travel time estimation method according to one aspect of the present invention is a travel time estimation method executed by an electronic device including a processing unit configured to estimate a travel time of a moving body on a predetermined route, and the travel time estimation method includes: a step of acquiring, by the electronic device, an estimated travel time of the moving body by adding a reference travel time of the moving body and a variable travel time that varies according to an external environment related to a traveling operation of the moving body, on the basis of a history of travel information of the moving body.

(2) The above aspect (1) may include a step of acquiring, by the electronic device, the variable travel time that stochastically varies according to a change in the external environment, on the basis of a history of information on the external environment.

(3) The above aspect (2) may include a step of acquiring, by the electronic device, an object avoidance time included in the variable travel time, by multiplying a probability (P_{obs}) that an object that hinders a traveling operation of the moving body is externally present by a time required for the moving body to avoid the object.

(4) The above aspect (3) may include a step of acquiring, as the probability (P_{obs}), by the electronic device using Bayes' theorem, a posterior probability P (ZA|XA) that is a probability that an avoidance operation of the moving body is executed in a state where the object is correctly detected by the moving body, on the basis of a formula (Equation 1) below described by: a prior probability P (ZA) that is a probability P (ZA₁) that an avoidance operation of the moving body is executed; a first conditional probability P (XA₁|ZA₁) that is a probability P (XA|ZA) that the object is correctly detected by the moving body in a state where an avoidance operation of the moving body is executed; a probability P (ZA₂) that an avoidance operation of the moving body is not executed; and a second conditional probability P (XA₂|ZA₂) that is a probability that the object is incorrectly detected by the moving body in a state where an avoidance operation of the moving body is not executed.

$${P}_{obs} = P ( ZA \vert XA ) = \frac{P ( XA \vert ZA ) \times P ( ZA )}{\{ P ( {ZA}_{1} ) \times P ( {XA}_{1} \vert {ZA}_{1} ) + P ( {ZA}_{2} ) \times P ( {XA}_{2} \vert {ZA}_{2} ) \}} \qquad ( EQUATION 1 )$$

(5) The above aspect (2) may include a step of acquiring, by the electronic device, an abnormality resolution time included in the variable travel time, by multiplying a probability (P_{com}) that an abnormality will occur in communication necessary for a traveling operation of the moving body by a time required for resolving the abnormality in the communication.

(6) The above aspect (5) may include a step of acquiring, as the probability (P_{com}), by the electronic device using Bayes' theorem, a posterior probability P (ZB|XB) that is a probability that a velocity of the moving body becomes equal to or less than a predetermined velocity in a state where the communication is abnormal, on the basis of a formula (Equation 2) below described by: a prior probability P (ZB) that is a probability P (ZB₂) that a velocity of the moving body becomes equal to or less than a predetermined velocity; a first conditional probability P (XB₂|ZB₂) that is a probability P (XB|ZB) that the communication is abnormal in a state where a velocity of the moving body is equal to or less than a predetermined velocity; a probability P (ZB₁) that a velocity of the moving body does not become equal to or less than a predetermined velocity; and a second conditional probability P (XB₁|ZB₁) that is a probability that the communication is normal in a state where a velocity of the moving body does not become equal to or less than a predetermined velocity.

$${P}_{com} = P ( ZB \vert XB ) = \frac{P ( XB \vert ZB ) \times P ( ZB )}{\begin{matrix}\{ P ( {ZB}_{1} ) \times P ( {XB}_{1} \vert {ZB}_{1} ) + P ( {ZB}_{2} ) \times \\ P ( {XB}_{2} \vert {ZB}_{2} ) \}\end{matrix}} \qquad ( EQUATION 2 )$$

(7) The above aspect (2) may include a step of acquiring, by the electronic device, an object avoidance time by multiplying a probability (P_{obs}) that an object that hinders a traveling operation of the moving body is externally present by time required for the moving body to avoid the object; a step of acquiring, by the electronic device, an abnormality resolution time by multiplying a probability (P_{com}) that an abnormality will occur in communication necessary for a traveling operation of the moving body by a time required for resolving the abnormality in the communication; and a step of acquiring, by the electronic device, the variable travel time by adding the object avoidance time and the abnormality resolution time.

(8) Any one of the above aspects (1) to (7) may include a step of acquiring, by the electronic device, the estimated travel time, for each of a plurality of routes provided between a first point and a second point; and a step of setting, by the electronic device, a route connecting the first point and the second point with one of the routes or a combination of a plurality of the routes selected from among the plurality of the routes on the basis of the respective estimated travel times.

(9) The above aspect (7) may include a step of acquiring, by the electronic device, a degree of contribution of the object to the estimated travel time on the basis of a ratio of the object avoidance time to the estimated travel time; a step of acquiring, by the electronic device, a degree of contribution of the abnormality in the communication to the estimated travel time on the basis of a ratio of the abnormality resolution time to the estimated travel time; a step of acquiring, by the electronic device, the estimated travel time, for each of a plurality of routes provided between a first point and a second point; and a step of setting, by the electronic device, a route connecting the first point and the second point with one of the routes or a combination of a plurality of the routes selected from among the plurality of the routes on the basis of at least one of the degree of contribution of the object or the degree of contribution of the abnormality in the communication.

(10) A travel time estimation device according to one aspect of the present invention includes: a processing unit configured to estimate a travel time of a moving body on a predetermined route, in which the processing unit acquires an estimated travel time of the moving body by adding a reference travel time of the moving body and a variable travel time that varies according to an external environment related to a traveling operation of the moving body, on the basis of a history of travel information of the moving body.

(11) A travel time estimation system according to one aspect of the present invention includes: an electronic device including a processing unit configured to estimate a travel time of a moving body on a predetermined route; a moving body control unit mounted on the moving body and communicably connected to the processing unit; and an information acquisitor mounted on the moving body and configured to acquire information on an external environment related to a traveling operation of the moving body, in which the moving body control unit transmits, to the processing unit, travel information of the moving body and information on the external environment acquired by the information acquisitor, the processing unit acquires an estimated travel time of the moving body by adding a reference travel time of the moving body and a variable travel time that varies according to the external environment on the basis of a history of each of the travel information of the moving body and the information on the external environment, and the processing unit transmits information related to the estimated travel time to the moving body control unit.

(12) A computer-readable non-temporary storage medium according to an aspect of the present invention stores a program causing a computer of an electronic device, which includes a processing unit configured to estimate a travel time of the moving body on a predetermined route, to execute a step of acquiring an estimated travel time of a moving body by adding a reference travel time of the moving body and a variable travel time that varies according to an external environment related to a traveling operation of the moving body, on the basis of a history of travel information of the moving body.

According to the above aspect (1), reliability of the estimated travel time (Tₖ) of the moving body can be improved by separately acquiring the reference travel time (T_{od}) and the variable travel time (Tₓ) that varies according to an external environment. It is possible to grasp a degree of contribution of a delay factor at a time of occurrence of delay due to the external environment, and it is possible to improve versatility of the estimated travel time (Tₖ) of the moving body.

In the case of the above aspect (2), reliability of the estimated travel time (Tₖ) can be further improved by acquiring the variable travel time (Tₓ) that stochastically varies according to a change in the external environment.

In the case of the above aspect (3), reliability of the estimated travel time (Tₖ) can be improved in consideration of delay due to the obstacle, by acquiring the object avoidance time (T_{obs}) included in the variable travel time (Tₓ).

In the case of the above aspect (4), the object avoidance time (T_{obs}) based on a history of information on the external environment can be estimated and updated with high accuracy by using the Bayes' theorem.

In the case of the above aspect (5), it is possible to improve reliability of the estimated travel time (Tₖ) in consideration of delay due to the abnormality in the communication, by acquiring the abnormality resolution time (T_{com}) included in the variable travel time (Tₓ).

In the case of the above aspect (6), the abnormality resolution time (T_{com}) based on a history of information on the external environment can be estimated and updated with high accuracy by using the Bayes' theorem.

In the case of the above aspect (7), reliability and versatility of the estimated travel time (Tₖ) can be further improved by separating the variable travel time (Tₓ), which stochastically varies according to a change in the external environment, into the object avoidance time (T_{obs}) and the abnormality resolution time (T_{com}) to acquire the variable travel time (Tₓ).

In the case of the above aspect (8), a route connecting the first point and the second point can be appropriately set based on the estimated travel time (Tₖ).

In the case of the above aspect (9), it is possible to improve reliability and versatility of route setting by considering the degree of contribution of the obstacle and the degree of contribution of the communication abnormality to the estimated travel time (Tₖ).

According to the above aspect (10), the above aspect (11), or the above aspect (12), reliability of the estimated travel time (Tₖ) of the moving body can be improved by separately acquiring the reference travel time (T_{od}) and the variable travel time (Tₓ) that varies according to an external environment. It is possible to grasp a degree of contribution of a delay factor at a time of occurrence of delay due to the external environment, and it is possible to improve versatility of the estimated travel time (Tₖ) of the moving body.

### BRIEF DESCRIPTION OF THE DRAWINGS

FIG. 1 is a constitution diagram of a travel time estimation system according to an embodiment of the present invention;

FIG. 2 is a flowchart illustrating an operation of the travel time estimation system according to the embodiment of the present invention;

FIG. 3 is a flowchart illustrating processing of correct/incorrect determination of obstacle detection by the travel time estimation system according to the embodiment of the present invention;

FIG. 4 is a diagram illustrating an example of an acquisition timing of determination information in the processing of correct/incorrect determination of obstacle detection by the travel time estimation system according to the embodiment of the present invention; and

FIG. 5 is a diagram illustrating an example of a curvature used for arithmetic operation of determination information in the processing of correct/incorrect determination of obstacle detection by the travel time estimation system according to the embodiment of the present invention.

### DETAILED DESCRIPTION OF THE INVENTION

Hereinafter, a travel time estimation system according to an embodiment of the present invention will be described with reference to the accompanying drawings.

The travel time estimation system according to the embodiment estimates a travel time of a moving body on a predetermined route. The moving body is, for example, a manned or unmanned vehicle, a moving work machine that performs predetermined work while traveling, other robot, or the like. For example, the moving body moves automatically or autonomously, moves in accordance with a manual operation (for example, a remote operation or the like) by an operator, or moves in accordance with a driving operation by an occupant.

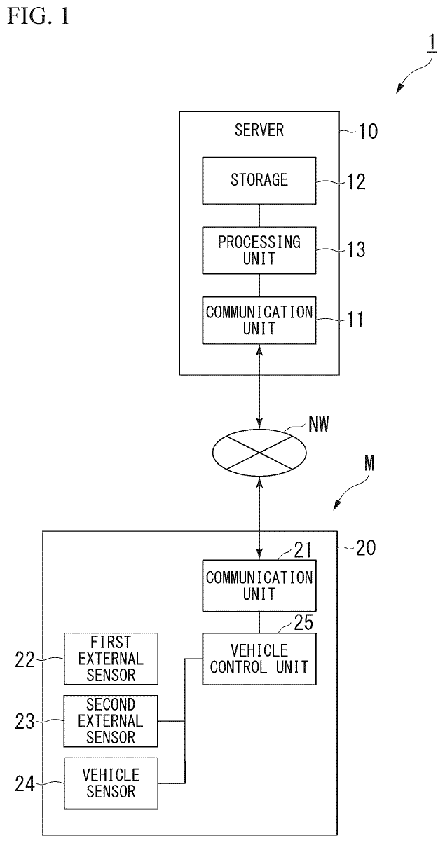

FIG. 1 is a constitution diagram of a travel time estimation system 1 according to an embodiment.

As illustrated in FIG. 1, the travel time estimation system 1 according to the embodiment includes: a server 10; and a terminal device 20 mounted on a moving body M, for example. The moving body M is, for example, a vehicle. The server 10 and the terminal device 20 of the moving body M are connected via, for example, a wired and wireless communication network (network) NW. The communication network NW is, for example, the Internet, a mobile communication network, a local area network (LAN), a wide area network (WAN), or the like. Examples of the LAN include a wired local area network (LAN) of a predetermined standard such as Ethernet and a wireless LAN of various standards such as Wi-Fi (registered trademark) and Bluetooth (registered trademark).

The server 10 includes, for example, a communication unit 11, a storage 12, and a processing unit 13.

The communication unit 11 communicates with, for example, the terminal device 20 of the moving body M.

The storage 12 stores, for example, various types of information, a predetermined program, and the like. The various types of information include, for example, predetermined route information set in advance for traveling of the moving body M, and a history of each of travel information and external environment information acquired from the moving body M.

The predetermined route information includes, for example, a plurality of nodes (nodal points) and a plurality of edges (line segment, route). Each of the plurality of nodes has position information such as latitude and longitude, for example. Each of the plurality of edges connects adjacent nodes in an appropriate combination, and has distance information between the connected nodes. The history of each of the travel information and the external environment information stored in the storage 12 is, for example, travel information and external environment information acquired from the moving body M over a predetermined information acquisition period retroactive from the present.

The travel information of the moving body M includes, for example, information regarding traveling such as a driving mode, a velocity, a steering angle, and a travel time for each time point at each of the plurality of edges. The driving mode is, for example, either an automatic or autonomous mode without operation by the operator or a manual mode with operation by the operator. The steering angle is, for example, a steering angle of a steering wheel of the moving body M. The travel time is, for example, a time required for traveling on each edge, and is a time obtained by integrating a travel time and a stop time in the edge.

The external environment information of the moving body M includes, for example, information on an external object and information on a communication state that are detected by the moving body M for each time point at each of the plurality of edges. The information on the external object is, for example, information on a position, a velocity, and the like of an object detected by each of a first external sensor 22 and a second external sensor 23 described later. The information on the communication state is, for example, information such as reference signal received power (RSRP) and reference signal received quality (RSRQ) detected by a communication unit 21 to be described later, and a time (recovery time) required for resolving an abnormality when a communication abnormality occurs.

The processing unit 13 includes a software functional unit that functions in accordance with a predetermined program executed by a processor such as a central processing unit (CPU). The software functional unit serves as an electronic control unit (ECU) including a processor such as a CPU, a read only memory (ROM) that stores a program, a random access memory (RAM) that temporarily stores data, and an electronic circuit such as a timer. At least a part of the processing unit 13 may be an integrated circuit such as a large scale integration (LSI).

For example, for each of the plurality of edges, the processing unit 13 acquires an estimated travel time (Tₖ) of the moving body M, by adding a reference travel time (T_{od}) of the moving body M and a variable travel time (Tₓ) that stochastically varies according to a change in the external environment, on the basis of a history of the travel information of the moving body M and a history of the external environment information related to a traveling operation of the moving body M. The processing unit 13 transmits, for example, information such as route information based on the estimated travel time (Tₖ), to the terminal device 20.

The terminal device 20 includes, for example, the communication unit 21, the first external sensor 22, the second external sensor 23, a vehicle sensor 24, and a vehicle control unit 25.

The communication unit 21 communicates with the server 10, for example.

The first external sensor 22 is, for example, a radar device. The first external sensor 22 detects, for example, a distance to an object, a position and a velocity of the object, and the like, by emitting an electromagnetic wave to surroundings of the moving body M and detecting reflection or scattering by the object present external to the moving body M.

The second external sensor 23 is, for example, a finder such as light detection and ranging or laser imaging detection and ranging (LIDAR). The second external sensor 23 detects, for example, a distance to an object, a position and a velocity of the object, and the like, by emitting light to surroundings of the moving body M and detecting reflection or scattering by the object present external to the moving body M.

The vehicle sensor 24 includes, for example, sensors that detect various types of information regarding a state of the moving body M, such as a velocity sensor that detects a velocity of the moving body M and a steering angle sensor that detects a steering angle of a steering wheel of the moving body M.

The vehicle control unit 25 includes a software functional unit that functions in accordance with a predetermined program executed by a processor such as a central processing unit (CPU). The software functional unit serves as an electronic control unit (ECU) including a processor such as a CPU, a read only memory (ROM) that stores a program, a random access memory (RAM) that temporarily stores data, and an electronic circuit such as a timer. At least a part of the vehicle control unit 25 may be an integrated circuit such as a large scale integration (LSI).

For example, the vehicle control unit 25 transmits travel information of the moving body M to the server 10, on the basis of data of a detection value output from the vehicle sensor 24. For example, the vehicle control unit 25 transmits information on an external object in the external environment information of the moving body M to the server 10, on the basis of data of a detection value output from each of the first external sensor 22 and the second external sensor 23. For example, the vehicle control unit 25 transmits information on a communication state in the external environment information of the moving body M to the server 10, on the basis of data of a detection value output from the communication unit 21.

The vehicle control unit 25 supports an operation of the moving body M by the operator by controlling an automatic or autonomous traveling operation of the moving body M, presenting information, or the like on the basis of information such as route information received from the server 10, for example.

Hereinafter, an operation of the travel time estimation system 1 of the embodiment, that is, a travel time estimation method executed by the travel time estimation system 1 will be described.

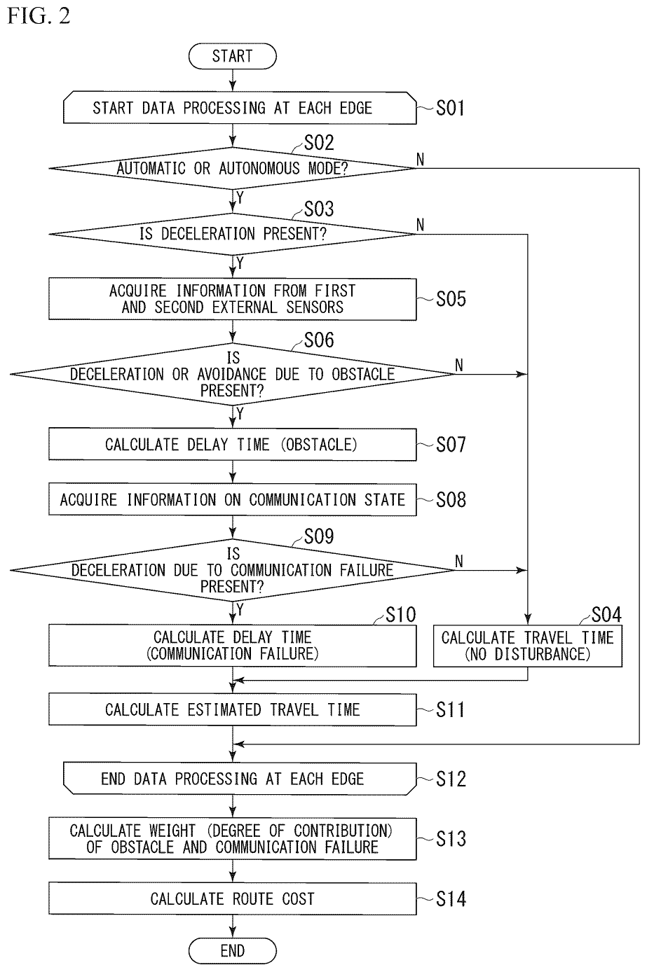

FIG. 2 is a flowchart illustrating an operation of the travel time estimation system 1 according to the embodiment.

As illustrated in FIG. 2, the processing unit 13 of the server 10 executes a series of data processing from step S01 to step S12 described below on travel information and external environment information for each time point at each of the plurality of edges, on the basis of data of various types of information stored in the storage 12. First, the processing unit 13 starts data processing at each edge (step S01).

Next, the processing unit 13 determines whether or not a driving mode in the travel information acquired from the storage 12 is an automatic or autonomous mode (step S02). When the determination result is “NO”, the processing unit 13 advances the processing to step S12. On the other hand, when the determination result is “YES”, the processing unit 13 advances the processing to step S03.

Next, the processing unit 13 determines the presence or absence of deceleration that is a state where the velocity of the moving body M in the travel information acquired from the storage 12 is equal to or less than a predetermined velocity (step S03). When the determination result is “NO”, the processing unit 13 advances the processing to step S04. On the other hand, when the determination result is “YES”, the processing unit 13 advances the processing to step S05.

Then, the processing unit 13 sets the travel time of the moving body M in the travel information acquired from the storage 12 as a travel time without disturbance, that is, a time required for traveling and stopping in a state without disturbance. For example, the processing unit 13 acquires a reference travel time T_{od} of the moving body M by integrating sequentially obtained travel times without disturbance and calculating an average value or the like (step S04).

The processing unit 13 acquires information on an external object based on detection by each of the first external sensor 22 and the second external sensor 23 in the external environment information in the storage 12 (step S05). Next, the processing unit 13 determines the presence or absence of deceleration or avoidance due to an obstacle, on the basis of the travel information and the external environment information acquired from the storage 12 (step S06). The deceleration is, for example, a state where a velocity of the moving body M is equal to or less than a predetermined velocity. The avoidance is, for example, a state where a change in the steering angle becomes a predetermined change or more due to manual operation of the steering wheel by the operator. When the determination result is “NO”, the processing unit 13 advances the processing to step S04 described above. On the other hand, when the determination result is “YES”, the processing unit 13 advances the processing to step S07.

Next, the processing unit 13 sets the travel time of the moving body M in the travel information acquired from the storage 12 as a delay time due to an obstacle, that is, a time required for the moving body M to avoid an object (obstacle) that hinders the traveling operation. For example, the processing unit 13 acquires a delay time t_{obs} due to the obstacle, by integrating sequentially obtained delay times due to the obstacle and calculating an average value or the like (step S07).

For example, the processing unit 13 acquires an object avoidance time T_{obs} by multiplying a probability P_{obs} of presence of the obstacle by the delay time t_{obs} due to the obstacle as shown in the following formula (Equation 3).

$${T}_{obs} ( k ) = {P}_{obs} \times {t}_{obs} \qquad ( EQUATION 3 )$$

For example, the processing unit 13 uses Bayes' theorem to acquire a posterior probability P (ZA|XA) described as shown in the following formula (Equation 4), as the probability P_{obs} of presence of an obstacle. The posterior probability P (ZA|XA) is a probability that an avoidance operation of the moving body Mis executed in a state where an obstacle is detected by the moving body M. As shown in the following formula (Equation 4), the posterior probability P (ZA|XA) is described by, for example, a prior probability P (ZA) that is a probability P (ZA₁) that an avoidance operation of the moving body M is executed, a probability P (ZA₂) that an avoidance operation of the moving body M is not executed, a first conditional probability P (XA₁|ZA₁), and a second conditional probability P (XA₂|ZA₂). The first conditional probability P (XA₁|ZA₁) is a probability P (XA|ZA) that an obstacle is correctly detected by the moving body M in a state where an avoidance operation of the moving body M is executed. The second conditional probability P (XA₂|ZA₂) is a probability that an obstacle is incorrectly detected by the moving body M in a state where an avoidance operation of the moving body M is not executed. An initial value of the prior probability P (ZA) is appropriately set on the basis of information in the past or the like.

$${P}_{obs} = P ( ZA \vert XA ) = \frac{P ( XA \vert ZA ) \times P ( ZA )}{{\sum }_{i = 1}^{n} \{ P ( {ZA}_{í} ) \times P ( {XA}_{i} \vert {ZA}_{i} ) \}} = \frac{P ( XA \vert ZA ) \times P ( ZA )}{\{ P ( {ZA}_{1} ) \times P ( {XA}_{1} \vert {ZA}_{1} ) + P ( {ZA}_{2} ) \times P ( {XA}_{2} \vert {ZA}_{2} ) \}} \qquad ( EQUATION 4 )$$

For example, the processing unit 13 calculates the probability P_{obs} of presence of an obstacle as shown in the following formula (Equation 5), by a combination of numerical data as shown in the following Table 1 and the above formula (Equation 4).

TABLE 1

| | Detected by sensor | Not detected by |
|---|---|---|
| | (XA₁) | sensor (XA₂) |
| Stop is necessary (ZA₁) | a: (0 < a < 1) | (1 − a) |
| Stop is unnecessary (ZA₂) | b: (0 < b < 1) | (1 − b) |

$$\begin{matrix}P ( ZA ) = c : ( 0 < c < 1 ) \\ {P}_{obs} = P ( ZA \vert XA ) = \frac{a \times c}{c \times a + ( 1 - c ) \times b}\end{matrix} \} \qquad ( EQUATION 5 )$$

“Detected by sensor (XA₁)” in Table 1 above is, for example, a case where an obstacle is correctly detected by the first external sensor 22 and the second external sensor 23. “Not detected by sensor (XA₂)” in Table 1 above is, for example, a case other than the case where an obstacle is correctly detected by the first external sensor 22 and the second external sensor 23. “Stop is necessary (ZA₁)” in Table 1 above is, for example, a case where deceleration or avoidance of the moving body M is executed. “Stop is unnecessary (ZA₂)” in Table 1 above is, for example, a case where deceleration and avoidance of the moving body M are not executed.

As shown in the above formula (Equation 5), the probability P_{obs} of presence of an obstacle is calculated from, for example, a probability “a” of a combination of “stop is necessary (ZA₁)” and “detected by sensor (XA₁)” in Table 1 above, a probability “b” of a combination of “stop is unnecessary (ZA₂)” and “detected by sensor (XA₁)”, and a probability “c” that is a total probability that deceleration or avoidance of the moving body M is executed, that is, a prior probability P (ZA).

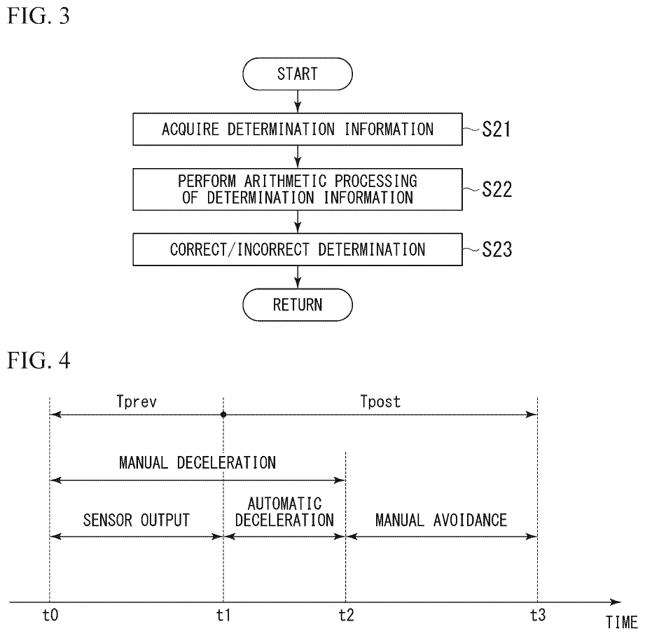

FIG. 3 is a flowchart illustrating processing of correct/incorrect determination of obstacle detection by the travel time estimation system 1 according to the embodiment.

For example, by executing a series of processing illustrated in FIG. 3, the processing unit 13 acquires numerical data as shown in Table 1 above.

First, the processing unit 13 acquires determination information on the basis of, for example, travel information and external environment information acquired from the storage 12 (step S21). For example, the determination information is: information (sensor output) on the presence or absence of detection of an external object by the first external sensor 22 and the second external sensor 23; information (automatic deceleration) on the presence or absence of automatic or autonomous deceleration of the moving body M; information (manual deceleration) on the presence or absence of deceleration of the moving body M according to an operation of the operator; and information on the presence or absence of subsequent avoidance of the moving body M according to an operation of the operator after deceleration of the moving body M (manual subsequent avoidance).

FIG. 4 is a diagram illustrating an example of an acquisition timing of determination information in the processing of correct/incorrect determination of obstacle detection by the travel time estimation system 1 according to the embodiment.

For example, as illustrated in FIG. 4, the processing unit 13 sets a predetermined pre-detection period Tprev before time t1 and a predetermined post-detection period Tpost after time t1, with reference to time t1 that is a timing of detection of the presence of an object (obstacle) that hinders the traveling operation of the moving body M, on the basis of data of detection values output from the sensors 22 and 23. The processing unit 13 acquires information on the sensor output, for example, in the predetermined pre-detection period Tprev that is a period from time t0 to time t1. For example, the processing unit 13 acquires information on “automatic deceleration” in a period from time t1 to time t2 in the predetermined post-detection period Tpost. For example, the processing unit 13 acquires information on “manual deceleration” in a period from time t0 to time t2. For example, the processing unit 13 acquires information on “manual subsequent avoidance” in a period from time t2 to time t3 which is an end time of the predetermined post-detection period Tpost.

Next, the processing unit 13 executes predetermined arithmetic processing on the basis of, for example, information (sensor output) on the presence or absence of detection of an external object by each of the sensors 22 and 23, thereby acquiring information (sensor output (two pieces)) on the presence or absence of detection of an obstacle by each of the sensors 22 and 23 (step S22). For example, in a case where external objects detected by the sensors 22 and 23 are the same and an existence region of the same object detected by the sensors 22 and 23 overlaps with a traveling region of the moving body M, the processing unit 13 determines that detection of an obstacle is present by the sensors 22 and 23.

For example, the processing unit 13 acquires a Mahalanobis distance D shown in the following formula (Equation 6), on the basis of data of a detection value output from each of the sensors 22 and 23. For example, in a case where the Mahalanobis distance D is equal to or less than a predetermined threshold value, the processing unit 13 determines that the external objects detected by the sensors 22 and 23 are the same. The Mahalanobis distance D shown in the following formula (Equation 6) is described by, for example, data x output from the first external sensor 22, data μ output from the second external sensor 23, and a variance-covariance matrix Σ of the data μ. Each of the data x and the data μ is, for example, a vector based on a position (pₓ, p_{y}) and a velocity (vₓ, v_{y}) in a two-dimensional space defined by an X-axis and a Y-axis orthogonal to each other.

$$D = \sqrt{{( x - μ )}^{T} {\sum }^{- 1} ( x - μ )} ; \{ x , μ = {( {p}_{x} , {p}_{y} , {v}_{x} , {y}_{y} )}^{T} \} \qquad ( EQUATION 6 )$$

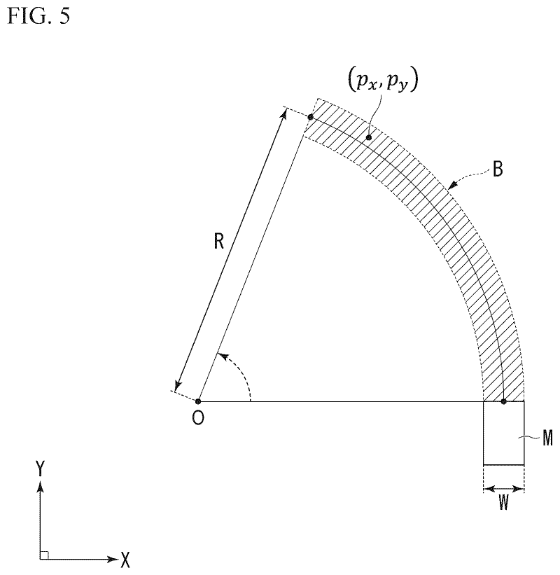

FIG. 5 is a diagram illustrating an example of a curvature used for arithmetic operation of determination information in the processing of correct/incorrect determination of obstacle detection by the travel time estimation system 1 according to the embodiment.

As illustrated in FIG. 5, the processing unit 13 acquires a curvature R shown in the following formula (Equation 7) on the basis of, for example, travel information acquired from the storage 12 and information known in advance regarding the moving body M. For example, the processing unit 13 sets a traveling region B of the moving body M in accordance with the curvature R and a width W of the moving body M. For example, when at least a part of the predetermined object region including a position (pₓ, p_{y}) of the data x or the data μ is included in the traveling region B, the processing unit 13 determines that an existence region of the same object detected by each of the sensors 22 and 23 overlaps with the traveling region of the moving body M. The curvature R shown in the following formula (Equation 7) is described by, for example, a velocity V, a stability factor A, a steering angle St, a steering angle gear ratio G, and a wheelbase L of the moving body M.

$$R = \frac{1 + A \times {V}^{2} \times L}{G \times St} \qquad ( EQUATION 7 )$$

Next, the processing unit 13 acquires numerical data as shown in Table 1 above by performing case classification of a combination of travel information and external environment information acquired from the storage 12, on the basis of the acquired determination information and a case classification list as shown in, for example, the following Table 2 and the following Table 3 (step S23). Then, the processing unit 13 advances the processing to the return.

TABLE 2

| | | Sensor | Deceler- | | |
|---|---|---|---|---|---|
| | | output | ation | | Subsequent |
| | | (two | (Auto- | Deceleration | avoidance |
| | | pieces) | matic) | (Manual) | (Manual) |
| Correct detection | | Present | Present | Absent | Absent |
| Incorrect | Over- | Absent | Present | Absent | Absent |
| detection | detection | | | | |
| (false | Non- | Absent | Absent | Present | Present |
| negative) | detection | | | | |

TABLE 3

| | Sensor | | | |
|---|---|---|---|---|
| | output | | | Subsequent |
| | (two | Deceleration | Deceleration | avoidance |
| | pieces) | (Automatic) | (Manual) | (Manual) |
| Incorrect detection | Present | Absent | Absent | Absent |
| (false negative) | | | | |
| Correct detection | Absent | Absent | Absent | Absent |

For example, Table 2 above is used to acquire respective probabilities “a” and (1−a) of “detected by sensor (XA₁)” and “not detected by sensor (XA₂)” in “stop is necessary (ZA₁)” in Table 1 above.

“Correct detection” in Table 2 above corresponds to a combination of “stop is necessary (ZA₁)” and “detected by sensor (XA₁)” in Table 1 above. In “correct detection” in Table 2 above, for example, determination information of each of “sensor output (two pieces)” and “automatic deceleration” is “present”, and determination information of each of “manual deceleration” and “manual subsequent avoidance” is “absent”. “Incorrect detection (false negative)” in Table 2 above corresponds to a combination of “stop is necessary (ZA₁)” and “not detected by sensor (XA₂)” in Table 1 above. “Incorrect detection (false negative)” in Table 2 above includes, for example, “over-detection” and “non-detection”. In “over-detection” in “incorrect detection (false negative)” in Table 2 above, for example, determination information of “automatic deceleration” is “present”, and determination information of each of “sensor output (two pieces)”, “manual deceleration”, and “manual subsequent avoidance” is “absent”. In “non-detection” in “incorrect detection (false negative)” of Table 2 above, for example, determination information of each of “manual deceleration” and “manual subsequent avoidance” is “present”, and determination information of each of “sensor output (two pieces)” and “automatic deceleration” is “absent”.

For example, Table 3 above is used to acquire respective probabilities “b” and (1−b) of “detected by sensor (XA₁)” and “not detected by sensor (XA₂)” in “stop is unnecessary (ZA₂)” in Table 1 above.

“Incorrect detection (false positive)” in Table 3 corresponds to a combination of “stop is unnecessary (ZA₂)” and “detected by sensor (XA₁)” in Table 1 above. In “incorrect detection (false positive)” of Table 3 above, for example, determination information of “sensor output (two pieces)” is “present”, and determination information of each of “automatic deceleration”, “manual deceleration”, and “manual subsequent avoidance” is “absent”.

“Correct detection” in Table 3 corresponds to a combination of “stop is unnecessary (ZA₂)” and “not detected by sensor (XA₂)” in Table 1 above. In “correct detection” in Table 3, for example, determination information of each of “sensor output (two pieces)”, “automatic deceleration”, “manual deceleration”, and “manual subsequent avoidance” is “absent”.

As illustrated in FIG. 2, next, the processing unit 13 acquires a time (recovery time) required for resolving a communication abnormality, from information on a communication state in the external environment information in the storage 12 (step S08). Next, the processing unit 13 determines the presence or absence of deceleration due to an abnormality in communication (communication failure), on the basis of the travel information and the external environment information acquired from the storage 12 (step S09). The deceleration is, for example, a state where a velocity of the moving body M is equal to or less than a predetermined velocity. When the determination result is “NO”, the processing unit 13 advances the processing to step S04 described above. On the other hand, when the determination result is “YES”, the processing unit 13 advances the processing to step S10.

Next, the processing unit 13 acquires a delay time t_{com} due to the communication failure, for example, by integrating sequentially obtained recovery times and calculating an average value or the like (step S10).

For example, the processing unit 13 acquires an abnormality resolution time T_{com} by multiplying a probability P_{com} of occurrence of the communication failure by the delay time t_{com} due to the communication failure, as shown in the following formula (Equation 8).

$${T}_{com} ( k ) = {P}_{com} \times {t}_{com} \qquad ( EQUATION 8 )$$

For example, the processing unit 13 uses Bayes' theorem to acquire a posterior probability P (ZB|XB) described as shown in the following formula (Equation 9), as the probability P_{com} of occurrence of the communication failure. The posterior probability P (ZB|XB) is a probability that a velocity of the moving body M becomes equal to or less than a predetermined velocity in a state where communication is abnormal. As shown in the following formula (Equation 9), the posterior probability P (ZB|XB) is described by, for example, a prior probability P (ZB) that is a probability P (ZB₂) that the velocity of the moving body M becomes equal to or less than a predetermined velocity, a probability P (ZB₁) that the velocity of the moving body M does not become equal to or less than a predetermined velocity, a first conditional probability P (XB₂|ZB₂), and a second conditional probability P (XB₁|ZB₁). The first conditional probability P (XB₂|ZB₂) is a probability P (XB|ZB) that communication is abnormal in a state where the velocity of the moving body M becomes equal to or less than a predetermined velocity. The second conditional probability P (XB₁|ZB₁) is a probability that communication is normal in a state where the velocity of the moving body M does not become equal to or less than a predetermined velocity. An initial value of the prior probability P (ZB) is appropriately set on the basis of information in the past or the like.

$${P}_{com} = P ( ZB \vert XB ) = \frac{P ( XB \vert ZB ) \times P ( ZB )}{{\sum }_{í = 1}^{n} \{ P ( {ZB}_{i} ) \times P ( {XB}_{i} \vert {ZB}_{i} ) \}} = \frac{P ( XB \vert ZB ) \times P ( ZB )}{\begin{matrix}\{ P ( {ZB}_{1} ) \times P ( {XB}_{1} \vert {ZB}_{1} ) + P ( {ZB}_{2} ) \times \\ P ( {XB}_{2} \vert {ZB}_{2} ) \}\end{matrix}} \qquad ( EQUATION 9 )$$

For example, the processing unit 13 calculates the probability P_{com} of occurrence of a communication failure as shown in the following formula (Equation 10), by a combination of numerical data as shown in the following Table 4 and the above formula (Equation 9).

TABLE 4

| | Favorable | Failed |
|---|---|---|
| | communication | communication |
| | (XB₁) | (XB₂) |
| Traveling (ZB₁) | (1 − e) | e: (0 < e < 1) |
| Stop (ZB₂) | (1 − d) | d: (0 < d < 1) |

$$\begin{matrix}P ( ZB ) = f : ( 0 < f < 1 ) \\ {P}_{obs} = P ( ZB \vert XB ) = \frac{d \times f}{f \times d + ( 1 - f ) \times e}\end{matrix} \} \qquad ( EQUATION 10 )$$

“Favorable communication (XB₁)” in Table 4 above is, for example, a case where communication is in a normal state, and reference signal received power (RSRP) and reference signal received quality (RSRQ) are equal to or more than respective predetermined thresholds. “Failed communication (XB₂)” in Table 4 above is, for example, a case where communication is in an abnormal state, and the reference signal received power (RSRP) and the reference signal received quality (RSRQ) are less than respective predetermined thresholds. “Traveling (ZB₁)” in Table 4 above is, for example, a case where a velocity (moving average value or the like) of the moving body Mis higher than a predetermined velocity. “Stop (ZB₂)” in Table 4 above is, for example, a case where a velocity (moving average value or the like) of the moving body M becomes equal to or less than a predetermined velocity.

As shown in the above formula (Equation 10), the probability P_{com} of occurrence of a communication failure is calculated from, for example, a probability “d” of a combination of “stop (ZB₂)” and “failed communication (XB₂)” in Table 4 above, a probability “e” of a combination of “traveling (ZB₁)” and “failed communication (XB₂)”, and a total probability that the velocity of the moving body M becomes equal to or less than a predetermined velocity, that is, a probability “f” that is the prior probability P (ZB).

Next, the processing unit 13 acquires an estimated travel time Tₖ of the moving body M at any given edge corresponding to any given natural number k, for example, as shown in the following formula (Equation 11) (step S11). For example, the processing unit 13 acquires the estimated travel time Tₖ of the moving body M, by adding a reference travel time T_{od} (k) of the moving body M and a variable travel time Tₓ (k) that varies according to an external environment related to the traveling operation of the moving body M. For example, the processing unit 13 sets addition of the object avoidance time T_{obs} (k) and the abnormality resolution time T_{com} (k) as the variable travel time Tₓ (k).

$${T}_{k} = {T}_{od} ( k ) + {T}_{x} ( k ) = {T}_{od} ( k ) + \{ {T}_{obs} ( k ) + {T}_{com} ( k ) \} \qquad ( EQUATION 11 )$$

Next, in a case where the acquisition of the estimated travel time Tₖ for each of the plurality of edges is completed, the processing unit 13 ends the data processing in each edge (step S12).

Next, the processing unit 13 acquires a degree of contribution (weight) C_{obs} (k) of an obstacle to the estimated travel time Tₖ and a degree of contribution (weight) C_{com} (k) of a communication failure to the estimated travel time Tₖ, for each of a plurality of edges, for example, as shown in the following formula (Equation 12) (step S13). The degree of contribution (weight) C_{obs} (k) of the obstacle is described by, for example, a ratio of the object avoidance time T_{obs} (k) to the estimated travel time Tₖ. The degree of contribution (weight) C_{com} (k) of the communication failure is described by, for example, a ratio of the variable travel time Tₓ (k) to the estimated travel time Tₖ.

$$\begin{matrix}{C}_{obs} ( k ) = 1 + \frac{{T}_{obs} ( k )}{{T}_{k}} \\ {C}_{com} ( k ) = 1 + \frac{{T}_{com} ( k )}{{T}_{k}}\end{matrix} \} \qquad ( EQUATION 12 )$$

Next, the processing unit 13 acquires an edge cost EC on the basis of at least one of the degree of contribution (weight) C_{obs} (k) of the obstacle or the degree of contribution (weight) C_{com} (k) of the communication failure, for each of the plurality of edges, for example, as shown in the following formula (Equation 13) (step S14). The edge cost EC is described by, for example, a distance DE of each edge, a velocity v of the moving body M at each edge, and a weight C by at least one of the degree of contribution (weight) C_{obs} (k) of the obstacle or the degree of contribution (weight) C_{com} (k) of the communication failure.

$$EC = \frac{DE}{v} \times C \qquad ( EQUATION 13 )$$

For example, in a case where there are a plurality of edges constituting a route connecting an appropriate first point and second point, the processing unit 13 can select an optimal route by selecting an edge having a small edge cost from among the plurality of edges. As a result, it is possible to shorten the travel time, improve the energy efficiency, secure the safety of traveling, and the like.

For example, the processing unit 13 sets one edge or a combination of a plurality of edges constituting a route connecting the first point and the second point, on the basis of the edge cost EC of each of the plurality of edges provided between the appropriate first point and second point. For example, the processing unit 13 acquires the cost of the route connecting the first point and the second point by integrating the edge cost EC and the like in accordance with the set one edge or the set combination of the plurality of edges. For example, the processing unit 13 transmits information such as the cost of the route to the vehicle control unit 25 of the terminal device 20. Then, the processing unit 13 advances the processing to the end.

As described above, according to the travel time estimation system 1 or the travel time estimation method of the embodiment, reliability of the estimated travel time (Tₖ) of the moving body M can be improved by separately acquiring the reference travel time (T_{od}) and the variable travel time (Tₓ) that varies according to an external environment. It is possible to grasp a degree of contribution of a delay factor at a time of occurrence of delay due to the external environment, and it is possible to improve versatility of the estimated travel time (Tₖ) of the moving body M.

Reliability of the estimated travel time (Tₖ) can be further improved by acquiring the variable travel time (Tₓ) that stochastically varies according to a change in the external environment.

Reliability of the estimated travel time (Tₖ) can be improved in consideration of delay due to an obstacle, by acquiring the object avoidance time (T_{obs}) included in the variable travel time (Tₓ). It is possible to improve reliability of the estimated travel time (Tₖ) in consideration of delay due to an abnormality in communication, by acquiring the abnormality resolution time (T_{com}) included in the variable travel time (Tₓ).

The object avoidance time (T_{obs}) and the abnormality resolution time (T_{com}) based on a history of information on the external environment can be estimated and updated with high accuracy by using the Bayes' theorem.

A route connecting the first point and the second point can be appropriately set on the basis of the estimated travel time (Tₖ).

It is possible to improve reliability and versatility of route setting by considering a degree of contribution of an obstacle and the degree of contribution of the communication abnormality to the estimated travel time (Tₖ).

### (Modification)

Hereinafter, a modification of the embodiment will be described. The same parts as those in the embodiment described above are denoted by the same reference numbers, and the description thereof will be omitted or simplified.

In the embodiment described above, all or a part of the processing executed by the processing unit 13 of the server 10 may be executed by the vehicle control unit 25 of the terminal device 20. For example, when all of the processing executed by the processing unit 13 is executed by the vehicle control unit 25, execution of the processing related to the abnormality resolution time (T_{com}) may be omitted.

In the embodiment described above, the processing unit 13 acquires determination information on the presence or absence of detection of an obstacle on the basis of data of detection values output from two sensors, that is, the first external sensor 22 and the second external sensor 23, but the present invention is not limited thereto. For example, the terminal device 20 may include three or more different external sensors, and the processing unit 13 may acquire determination information on the presence or absence of detection of an obstacle is present on the basis of detection values of the three or more different external sensors.

In the embodiment described above, when both the degree of contribution (weight) C_{obs} (k) of an obstacle and the degree of contribution (weight) C_{com} (k) of a communication failure are reflected to the edge cost EC of each edge, the estimated travel time Tₖ may be adopted as the edge cost EC.

In the embodiment described above, the moving body M is a vehicle, but the present invention is not limited thereto. For example, the moving body M may be a working machine having a carrier for conveyance, a working machine having a working unit such as a lawn mower, or the like. The working machine may be autonomously movable, or may be movable according to an operation by the operator, a driving operation by an occupant, or the like.

A program for achieving all or some of the functions of the travel time estimation system 1 in the present invention may be recorded in a computer-readable recording medium, and the program recorded in such a recording medium may be read and executed by a computer system, and all or a part of the processing may be performed by the travel time estimation system 1. The “computer system” mentioned herein includes an OS and hardware such as peripheral devices. The “computer system” also includes a WWW system including a website providing environment (or display environment). The “computer-readable recording medium” refers to a portable medium such as a flexible disk, a magneto-optical disk, a ROM, and a CD-ROM, and a storage device such as a hard disk built in a computer system. Furthermore, the “computer-readable recording medium” includes a medium that holds a program for a certain period of time, such as a volatile memory (RAM) inside a computer system that serves as a server or a client, when the program is transmitted through a network such as the Internet or a communication line such as a telephone line.

The program described above may be transmitted from a computer system in which the program is stored in a storage device or the like to another computer system, through a transmission medium or on transmission waves in the transmission medium. Here, the “transmission medium” for transmitting a program refers to a medium having a function of transmitting information, such as a network (communication network) such as the Internet or a communication line such as a telephone line. The above program may be made for achieving some of the above-described functions. Furthermore, a program capable of achieving the above-described functions in combination with a program already recorded in the computer system, that is, a so-called differential file (differential program) may be applicable.

The embodiment of the present invention has been presented by way of examples, and there is no intention of limiting the scope of the invention. The embodiment can be implemented in various other forms, and various omissions, substitutions, and changes can be made without departing from the gist of the invention. These embodiments and modifications are included in the scope and gist of the invention, and are also included in the invention described in claims and the equivalent scope thereof.

What is claimed is:

1. A travel time estimation method executed by an electronic device including a processing unit configured to estimate a travel time of a moving body on a predetermined route, the travel time estimation method comprising:
a step of acquiring, by the electronic device, an estimated travel time of the moving body by adding a reference travel time of the moving body and a variable travel time that varies according to an external environment related to a traveling operation of the moving body, on a basis of a history of travel information of the moving body.

2. The travel time estimation method according to claim 1, comprising:
a step of acquiring, by the electronic device, the variable travel time that stochastically varies according to a change in the external environment, on a basis of a history of information on the external environment.

3. The travel time estimation method according to claim 2, comprising:
a step of acquiring, by the electronic device, an object avoidance time included in the variable travel time, by multiplying a probability (P_{obs}) that an object that hinders a traveling operation of the moving body is externally present by a time required for the moving body to avoid the object.

4. The travel time estimation method according to claim 3, comprising:
a step of acquiring, as the probability (P_{obs}), by the electronic device using Bayes' theorem, a posterior probability P (ZA|XA) that is a probability that an avoidance operation of the moving body is executed in a state where the object is correctly detected by the moving body,
on a basis of a formula (Equation 1) below described by:
a prior probability P (ZA) that is a probability P (ZA₁) that an avoidance operation of the moving body is executed;
a first conditional probability P (XA₁|ZA₁) that is a probability P (XA|ZA) that the object is correctly detected by the moving body in a state where an avoidance operation of the moving body is executed;
a probability P (ZA₂) that an avoidance operation of the moving body is not executed; and
a second conditional probability P (XA₂|ZA₂) that is a probability that the object is incorrectly detected by the moving body in a state where an avoidance operation of the moving body is not executed:
$${P}_{obs} = P ( ZA \vert XA ) = \frac{P ( XA \vert ZA ) \times P ( ZA )}{\{ P ( {ZA}_{1} ) \times P ( {XA}_{1} \vert {ZA}_{1} ) + P ( {ZA}_{2} ) \times P ( {XA}_{2} \vert {ZA}_{2} ) \}} \qquad ( EQUATION 1 )$$

5. The travel time estimation method according to claim 2, comprising:
a step of acquiring, by the electronic device, an abnormality resolution time included in the variable travel time, by multiplying a probability (P_{com}) that an abnormality will occur in communication necessary for a traveling operation of the moving body by a time required for resolving the abnormality in the communication.

6. The travel time estimation method according to claim 5, comprising:
a step of acquiring, as the probability (P_{com}), by the electronic device using Bayes' theorem, a posterior probability P (ZB|XB) that is a probability that a velocity of the moving body becomes equal to or less than a predetermined velocity in a state where the communication is abnormal,
on a basis of a formula (Equation 2) below described by:
a prior probability P (ZB) that is a probability P (ZB₂) that a velocity of the moving body becomes equal to or less than a predetermined velocity;
a first conditional probability P (XB₂|ZB₂) that is a probability P (XB|ZB) that the communication is abnormal in a state where a velocity of the moving body is equal to or less than a predetermined velocity;
a probability P (ZB₁) that a velocity of the moving body does not become equal to or less than a predetermined velocity; and
a second conditional probability P (XB₁|ZB₁) that is a probability that the communication is normal in a state where a velocity of the moving body does not become equal to or less than a predetermined velocity:
$${P}_{com} = P ( ZB \vert XB ) = \frac{P ( XB \vert ZB ) \times P ( ZB )}{\begin{matrix}\{ P ( {ZB}_{1} ) \times P ( {XB}_{1} \vert {ZB}_{1} ) + P ( {ZB}_{2} ) \times \\ P ( {XB}_{2} \vert {ZB}_{2} ) \}\end{matrix}} \qquad ( EQUATION 2 )$$

7. The travel time estimation method according to claim 2, comprising:
a step of acquiring, by the electronic device, an object avoidance time by multiplying a probability (P_{obs}) that an object that hinders a traveling operation of the moving body is externally present by time required for the moving body to avoid the object;
a step of acquiring, by the electronic device, an abnormality resolution time by multiplying a probability (P_{com}) that an abnormality will occur in communication necessary for a traveling operation of the moving body by a time required for resolving the abnormality in the communication; and
a step of acquiring, by the electronic device, the variable travel time by adding the object avoidance time and the abnormality resolution time.

8. The travel time estimation method according to claim 1, comprising:
a step of acquiring, by the electronic device, the estimated travel time, for each of a plurality of routes provided between a first point and a second point; and
a step of setting, by the electronic device, a route connecting the first point and the second point with one of the routes or a combination of a plurality of the routes selected from among the plurality of the routes on a basis of the respective estimated travel times.

9. The travel time estimation method according to claim 7, comprising:
a step of acquiring, by the electronic device, a degree of contribution of the object to the estimated travel time on a basis of a ratio of the object avoidance time to the estimated travel time;
a step of acquiring, by the electronic device, a degree of contribution of the abnormality in the communication to the estimated travel time on a basis of a ratio of the abnormality resolution time to the estimated travel time;
a step of acquiring, by the electronic device, the estimated travel time, for each of a plurality of routes provided between a first point and a second point; and
a step of setting, by the electronic device, a route connecting the first point and the second point with one of the routes or a combination of a plurality of the routes selected from among the plurality of the routes on a basis of at least one of the degree of contribution of the object or the degree of contribution of the abnormality in the communication.

10. A travel time estimation device comprising:
a processing unit configured to estimate a travel time of a moving body on a predetermined route, wherein
the processing unit acquires an estimated travel time of the moving body by adding a reference travel time of the moving body and a variable travel time that varies according to an external environment related to a traveling operation of the moving body, on a basis of a history of travel information of the moving body.

11. A travel time estimation system, comprising:
an electronic device including a processing unit configured to estimate a travel time of a moving body on a predetermined route;
a moving body control unit mounted on the moving body and communicably connected to the processing unit; and
an information acquisitor mounted on the moving body and configured to acquire information on an external environment related to a traveling operation of the moving body, wherein
the moving body control unit transmits, to the processing unit, travel information of the moving body and information on the external environment acquired by the information acquisitor, and
the processing unit acquires an estimated travel time of the moving body by adding a reference travel time of the moving body and a variable travel time that varies according to the external environment on a basis of a history of each of the travel information of the moving body and the information on the external environment, and the processing unit transmits information related to the estimated travel time to the moving body control unit.

12. A computer-readable non-temporary storage medium storing a program causing a computer of an electronic device, which includes a processing unit configured to estimate a travel time of the moving body on a predetermined route, to execute
a step of acquiring an estimated travel time of a moving body by adding a reference travel time of the moving body and a variable travel time that varies according to an external environment related to a traveling operation of the moving body, on a basis of a history of travel information of the moving body.
